(19) United States
(12) Patent Application Publication
(10) Pub. No.: US 2002/0102462 A1
(43) Pub. Date: Aug. 1, 2002

(54) Electrodes for lithium batteries

(76) Inventors: Robert A. Huggins, Stanford, CA (US); Andreas Netz, Kiel (DE)

Correspondence Address: Robert A. Huggins, 824 San Francisco Ct., Stanford, CA, 94305, US

(21) Appl. No.: 10/005,450

(22) Filed: Dec. 3, 2001

Related U.S. Application Data
(60) Provisional application No. 60/251,752, filed on Dec. 6, 2000.

(51) Int. Cl. H01M 4/40

(52) U.S. Cl. 429/231.9; 429/231.95; 205/59

(57) ABSTRACT

A method to reduce the initial irreversible capacity in an alkali metal-based electrochemical cell, and thus the necessity for the presence of an additional alkali metal source material in the cell comprising a pre-charging step performed by either electrochemical or chemical means.

### FIELD OF THE INVENTION

This application relates to improvements in the properties of negative electrodes in lithium battery systems and the lithium batteries that contain them.

### BACKGROUND OF THE INVENTION

Current Negative Electrode Technology in Lithium Batteries

Current negative electrodes involve the insertion and extraction of lithium from graphite and other carbons. The maximum specific capacity is determined by the amount of lithium that can be inserted into the graphite crystal structure. This is represented by the formula LiC₆, and theoretically amounts to 372 mAh/g of carbon weight. Practical values in commercial cells typically fall in the range 300-350 mAh/g.

Alternatives to Lithium-Carbon Electrodes

There have been a number of attempts to find or develop materials that would have higher capacities, as well as other potential advantages over the properties of the lithium-carbons.

Following a surprise announcement by Fujifilm [“Fujifilm Develops New Generation Lithium Ion Secondary Battery—Featuring the World's Largest Capacity and Energy Density”, Internet: http://www.fujifilm.cojp/eng/news_e/nr079.html, and also Y. Idota, et al., “Tin-Based Amorphous Oxide: A High-Capacity Lithium-Ion-Storage Material”, Science, 276, 1395 (1997)] one of the approaches that has received a lot of attention recently involves the use of convertible metal oxides. During the initial charging (lithiation) of the electrode lithium reacts with these oxides to produce lithium oxide, as well as the corresponding metal. Subsequently, this metal product reacts with additional lithium. Thus the amount of lithium that is initially absorbed is composed of two parts. One part results in the formation of the lithium oxide, and is irreversible. The other part generates potentially reversible capacity.

Some other non-oxide materials have been found that also have an initial lithiation capacity that contains both irreversible and reversible components. In those cases some of the lithium that is put into the electrode the first time that it is charged remains trapped, and is not accessible within the potential range of the operation of the electrode subsequently.

Some of these alternative materials have been found in which the reversible part of the total capacity is very attractive, being significantly greater than the capacity of the lithium-carbons. On the other hand, the irreversible capacity is highly deleterious, for it requires the initial presence of extra lithium within the cell that cannot be used during subsequent cycling. This sacrificial lithium has to come from somewhere inside the cell container, and the most obvious solution is to include additional positive electrode reactant material. Because the currently used positive electrode materials have relatively low lithium capacities, roughly 120-140 mAh/g, this is not a favorable solution, for it adds significantly to the overall mass and volume.

To illustrate the magnitude of the irreversible lithium consumption, theoretical data on the irreversible and reversible capacities of some simple binary oxides are shown in Table 1.

TABLE 1
Theoretical reversible and irreversible capacities
of a number of simple oxides.

| | Reversible | Irreversible | Ratio |
|---|---|---|---|
| | Capacity | Capacity | Reversible / |
| Material | mAh/g | mAh/g | Total |
| SnO | 875 | 398 | 0.69 |
| SnO₂ | 782 | 711 | 0.52 |
| ZnO | 493 | 659 | 0.43 |
| CdO | 605 | 417 | 0.59 |
| PbO | 540 | 240 | 0.69 |
| SiO | 2675 | 1216 | 0.69 |

An Example Demonstrating the Irreversible and Reversible Capacity of an Oxide Containing Tin

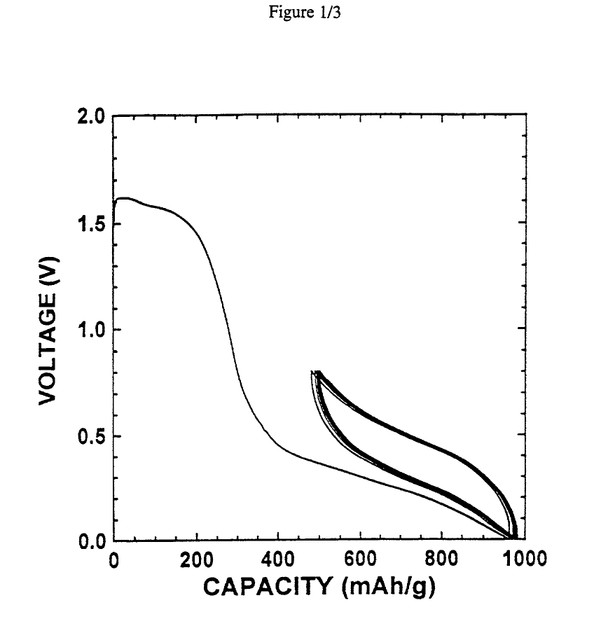

As an example, experimental data for an oxide glass, Sn₂BPO₆, are shown in FIG. 1. The data are from “Key Factors Controlling the Reversibility of the Reaction of Lithium with SnO₂ and Sn₂BPO₆ Glass”, by I. A. Courtney and J. R. Dahn, J. Electrochem. Soc. 144, 2943 (1997). It is seen that, although the initial lithiation of this material gave a capacity of about 980 mAh/g, the subsequent reversible capacity was only about 480 mAh/g. The difference of about 500 mAh/g was irreversible, and resulted from the reaction of lithium with the initial oxide to form non-reversible lithium oxide.

### DETAILED DESCRIPTION OF THE FIGURES

FIG. 1 is a graph showing the relationship between the voltage and the capacity of Sn₂BPO₆ glass upon cycling. Upon initial charging there is a capacity of 980 mAh/g, but a capacity of only about 480 mAh/g is found during the first discharge. The difference, about 500 mAh/g, is irreversible capacity loss. Subsequent cycles evidence only the reversible 480 mAh/g.

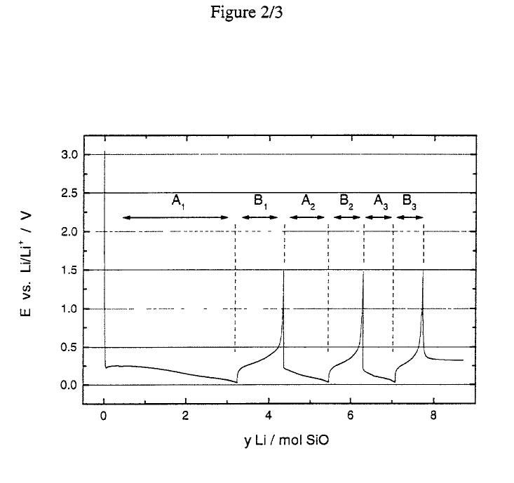

FIG. 2 is a graph showing the results of three discharge-charge cycles of SiO without prelithiation. A₁ represents the magnitude of the capacity upon the first charging cycle, and B₁ represents the magnitude of the capacity during the first discharge cycle. Likewise, A₂ and B₂ represent the magnitudes of the charging and discharging capacity in the second cycle, and A₃ and B₃ the corresponding values for the third cycle.

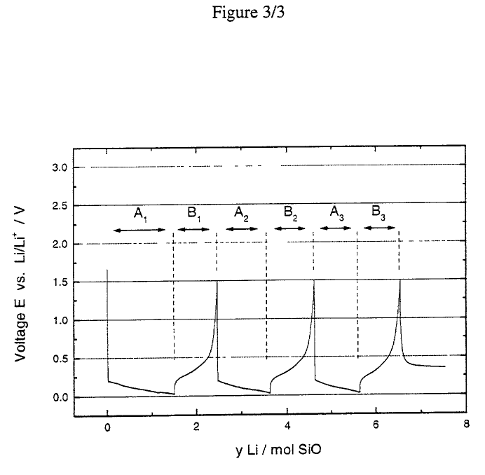

FIG. 3 is a graph showing the results of three discharge-charge cycles of SiO after electrochemical pre-lithiation. A₁ represents the magnitude of the capacity upon the first charging cycle, and B₁ represents the magnitude of the capacity during the first discharge cycle. Likewise, A₂ and B₂ represent the magnitudes of the charging and discharging capacity in the second cycle, and A₃ and B₃ the corresponding values for the third cycle.

### SUMMARY OF THE INVENTION

This invention provides for improved capacity of lithium batteries. This is due to a substantial improvement of the properties of the negative electrode. A number of otherwise attractive negative electrode materials suffer from a serious disadvantage due to their reaction with a large amount of extra lithium the first time that they are charged. This extra lithium cannot be recovered and employed during subsequent charge-discharge cycles. It therefore represents irreversible and unusable capacity in the negative electrode, which must be balanced by the presence of extra sacrificial capacity, with its concommitant mass and volume, in the positive electrode, thus negatively affecting the properties of the battery as a whole.

By means of the methods employed in this invention the properties of such lithium battery negative electrodes can be substantially improved by performing the initial charging (lithiation) of the negative electrode prior to the final assembly of the battery. This can be done either by the use of a chemical reactant, or by the employment of an electrochemical cell, to supply said extra lithium. It can also be done at several different levels; individual materials, combinations of materials, electrode components, or assembled electrodes. The result is that there is little or no irreversible capacity during the normal operation of the battery.

It is an object of this invention to produce electrodes for lithium battery systems with enhanced reversible lithium utilization and reduced irreversible capacity.

It is a further object of this invention to reduce the need for the presence of additional lithium sources within the electrochemical cell.

It is a further object of this invention to provide a method to avoid initial irreversible capacity by performing the initial lithiation of the electrode or components thereof outside of, or prior to the final assembly, of the electrochemical cell.

It is a further object of this invention to do the initial lithiation either chemically or electrochemically.

### DETAILED DESCRIPTION OF THE INVENTION

This invention provides a method to avoid the initial irreversible capacity in a lithium-based electrochemical cell, and thus the necessity for the presence of an additional lithium source material in the cell.

This can be accomplished simply and economically by performing the initial lithiation cycle of the negative electrode reactant material outside of the battery. Subsequently, this material is inserted into the final battery to operate as the negative electrode.

This external pre-lithiation cycle can be done either chemically or electrochemically. There are two further possibilities. One is to perform the initial lithiation upon a prepared electrode, and the other is to perform the lithiation upon one or more of the components of the final electrode structure.

In order for the pre-lithiation to be done chemically, the electrode material must react with a chemical lithium source that has a lithium activity greater than that of the material to be lithiated. A number of materials have been used as chemical lithium sources for reactants that operate are relatively high potentials, such as those used as positive electrode materials in lithium systems. This can also, in principle, be done with negative electrode materials.The requirement is that the reaction potential of the lithium source must be lower than that of the material being lithiated in order to supply lithium to it. Examples of well-known chemical lithium sources and their reaction potentials are included in Table 2.

TABLE 2
Examples of materials that can be used for chemical lithiation

| Material | Volts vs Li/Li⁺ |
|---|---|
| LiBr | 3.54 |
| LiI | 2.79 |
| n-butyl lithium | 1.0 |
| LiBH₄ | 0.87 |
| LiH | 0.71 |
| Li₃N | 0.44 |

The other alternative is to perform the initial external lithiation electrochemically. As mentioned above, there are also two possibilities for this approach.

One is to perform the initial lithiation upon a normal electrode structure by inserting said structure in a simple electrochemical cell external to the final battery and to use lithium or some other lithium-containing material with the appropriate polarity as the lithium source. After passing current through the cell in order to cause the reaction of lithium with the electrode structure, the lithiated electrode is removed, and subsequently inserted into the battery. A variant would be to perform the initial lithiation upon the negative electrode structure in-situ within the cell, using an external lithium-providing electrode, prior to the final sealing of the cell.

The second possibility is to do the initial external electrochemical lithiation on the primary electrode reactant, or on a combination of components, rather than upon the complete electrode.

This electrochemical pre-treatment can be done either galvanostatically or potentiostatically, or a combination of both.

Following this pre-lithiation cycle, there will be much less initial irreversible capacity, only the reversible capacity, during operation of the second (final) cell, the assembled battery.

The use of this invention thus makes a number of the oxides, alloys, and other convertible electrode materials much more attractive candidates for use in practical cells by reducing the deleterous irreversible reaction with lithium, the so-called irreversible capacity.

There are some advantages to the use of electrochemical, rather than chemical, prelithiation. One is that a full cycle of lithiation and lithium extraction can be readily performed. This leaves the electrode material at a high potential, and therefore at a low lithium activity (content) such that it is less sensitive to air and water vapor and can be easily handled and inserted into the battery. This is more attractive for battery manufacture, for they are typically produced in the discharged state. Subsequently, during the first charging, lithium is transferred from the positive electrode reactant and to the negative electrode reactant. This raises the potential of the positive electrode, and reduces that of the negative electrode, preparing the battery for use as a current source.

Although the above discussion has implied that the initial pre-lithiation cycle is to be done galvanostatically and to be performed only once, other variations are possible. For example, the first lithiation cycle could include both galvanostatic and potentiostatic components. Another variation would be to perform this initial lithiation using more than one cycle in order to increase the thoroughness of the irreversible lithiation process.

This method can be utilized at elevated temperatures as well as at ambient temperatures. In some cases, this will increase the kinetics, or result in other advantages.

It is also not necessary that the electrolyte employed for the pre-lithiation be the same as that utilized in the final electrochemical cell.

### EXAMPLE

An example of the use of this invention is the external electrochemical initial lithiation of SiO. An electrode was constructed by placing of a 30 micrometer thick layer of SiO, plus a binder and electronically conducting carbon in the ratio (85/10/5), on a copper foil substrate by tape casting. This was followed by heating to about 110° C. for 24 hours to drive off volatile parts of the binder. This electrode was then inserted into a simple coffee-bag type of cell with a fiberglass separator filled with a liquid electrolyte (LiPF₆ in an EC-DEC solution) and a lithium counter electrode.

Current was passed through the cell at a rate of 0.1 mA/cm² for some 74 hours, until the potential reached 25 mV vs Li. This introduced 3.24 moles of lithium per mol of SiO. The direction of the current was then reversed until the potential reached 3 V vs Li. This caused the removal of the reversible lithium, but not the irreversible lithium. The amount of electrical charge necessary to reach this voltage limit converted to 1.1 mol of reversible lithium extracted. This extracted lithium could then be further cycled. The remaining 2.13 mols of lithium was irreversible and could not be utilized. This is shown in FIG. 2.

A similar experiment was conducted upon a cell in which the SiO negative electrode had been given the same first cycle electrochemical galvanostatic lithiation treatment as in the case described above. However, in this second case the electrode was then removed from this initial lithiation cell, and inserted into a “final” cell. The properties of the “final” cell were then measured under similar galvanostatic cycling conditions. The results are shown in FIG. 3 and Table 4. It can readily be seen that the large initial irreversible capacity visible in the cell of FIG. 2 has been greatly reduced in the second case, from 2.13 mols of lithium per mol of SiO to only 0.55 mols of lithium per mol of SiO, illustrating the advantage of this method.

FIGS. 2 and 3 can more readily be understood by means of the following tabular data.

The capacity data for each of the charge and discharge cycles of this material without prelithiation are included in Table 3.

The capacity data for each of the charge and discharge cycles of this material after electrochemical pre-lithiation are included in Table 4.

TABLE 3
Capacity values measured during cycling SiO electrode
without pre-lithiation.

| Cycle | y Li in Li_{y}SiO | Capacity / mAh/g |
|---|---|---|
| First charge | +3.24 | +1969 |
| First discharge | −1.11 | −676 |
| Second charge | +1.12 | +679 |
| Second discharge | −0.83 | −508 |
| Third charge | +0.78 | +472 |
| Third discharge | −0.66 | −403 |

TABLE 4
Capacity values measured during cycling SiO electrode after
electrochemical pre-lithiation.

| Cycle | y Li in Li_{y}SiO | Capacity / mAh/g |
|---|---|---|
| First charge | +1.51 | +920 |
| First discharge | −0.96 | −582 |
| Secondcharge | +1.16 | +704 |
| Second discharge | −1.00 | −606 |
| Third charge | +1.02 | +620 |
| Third discharge | −0.91 | −551 |

Other Embodiments of the Invention

There are many preferred embodiments of the present invention. These include the following.

A method to form an electrode for a lithium battery by internal chemical prelithiation; a method to form an electrode for a lithium battery by means of internal electrochemical prelithiation; a method to process a negative electrode material for a lithium battery by external chemical prelithiation; a method to process a negative electrode material for a lithium battery by means of external electrochemical prelithiation; an electrode for use in a lithium battery, said electrode containing lithium introduced chemically external to the final electrochemical cell, such that the initial irreversible capacity is greatly reduced; an electrode for use in a lithium battery, said electrode comprising lithium introduced electrochemically in a cell other than the final electrochemical cell, such that the initial irreversible capacity is greatly reduced; an electrode for use in a lithium battery, said electrode containing one or more component materials into which lithium was introduced chemically externally prior to the final assembly, such that the initial irreversible capacity is greatly reduced; an electrode for use in a lithium battery, said electrode containing one or more component materials into which lithium was introduced electrochemically externally prior to the final assembly, such that the initial irreversible capacity is greatly reduced.

What is claimed is:

1. A method to produce an alkali metal battery that has reduced irreversible capacity comprising the step of performing the initial charging cycle of the negative electrode prior to final assembly.

2. A method as described in claim 1 to produce a lithium battery that has reduced irreversible capacity comprising the step of performing the initial charging cycle of the negative electrode prior to final assembly.

3. A method as described in claim 1 to produce a sodium battery that has reduced irreversible capacity comprising the step of performing the initial charging cycle of the negative electrode prior to final assembly.

4. A method as described in claim 1 to produce a potassium battery that has reduced irreversible capacity comprising the step of performing the initial charging cycle of the negative electrode prior to final assembly.

5. A method to reduce the irreversible capacity of an alkali metal battery comprising the step of performing a pre-charging cycle upon the negative electrode externally prior to the assembly of the battery.

6. A method as described in claim 5 to reduce the irreversible capacity of a lithium battery comprising the step of performing a pre-charging cycle upon the negative electrode externally prior to the assembly of the battery.

7. A method as described in claim 5 to reduce the irreversible capacity of a sodium battery comprising the step of performing a pre-charging cycle upon the negative electrode externally prior to the assembly of the battery.

8. A method as described in claim 5 to reduce the irreversible capacity of a potassium battery comprising the step of performing a pre-charging cycle upon the negative electrode externally prior to the assembly of the battery.

9. A method to form an electrode from a material for an alkali metal battery comprising the step of introducing the alkali metal into the material by chemical reaction prior to the assembly of the battery.

10. A method as described in claim 9 to form an electrode from a material for a lithium battery comprising the step of introducing lithium into the material by chemical reaction prior to the assembly of the battery.

11. A method as described in claim 9 to form an electrode from a material for a sodium battery comprising the step of introducing sodium into the material by chemical reaction prior to the assembly of the battery.

12. A method as described in claim 9 to form an electrode from a material for a potassium battery comprising the step of introducing potassium into the material by chemical reaction prior to the assembly of the battery.

13. A method to form an electrode from a material for an alkali metal battery comprising the step of introducing the alkali metal into the material by external electrochemical pre-charging prior to the assembly of the battery.

14. A method as described in claim 13 to form an electrode from a material for a lithium battery comprising the step of introducing lithium into the material by external electrochemical pre-charging prior to the assembly of the battery.

15. A method as described in claim 13 to form an electrode from a material for a sodium battery comprising the step of introducing sodium into the material by external electrochemical pre-charging prior to the assembly of the battery.

16. A method as described in claim 13 to form an electrode from a material for a potassium battery comprising the step of introducing potassium into the material by external electrochemical pre-charging prior to the assembly of the battery.

17. A method to produce an alkali metal battery that has reduced irreversible capacity comprising the step of performing an internal chemical pre-charging of the negative electrode prior to final assembly.

18. A method as described in claim 17 to produce a lithium battery that has reduced irreversible capacity comprising the step of performing an internal chemical pre-charging of the negative electrode prior to final assembly.

19. A method as described in claim 17 to produce a sodium battery that has reduced irreversible capacity comprising the step of performing an internal chemical pre-charging of the negative electrode prior to final assembly.

20. A method as described in claim 17 to produce a potassium battery that has reduced irreversible capacity comprising the step of performing an internal chemical pre-charging of the negative electrode prior to final assembly.

21. A method to produce an alkali metal battery that has reduced irreversible capacity comprising the step of performing an internal electrochemical pre-charging of the negative electrode prior to final assembly.

22. A method as described in claim 21 to produce a lithium battery that has reduced irreversible capacity comprising the step of performing an internal electrochemical pre-charging of the negative electrode prior to final assembly.

23. A method as described in claim 21 to produce a sodium battery that has reduced irreversible capacity comprising the step of performing an internal electrochemical pre-charging of the negative electrode prior to final assembly.

24. A method as described in claim 21 to produce a potassium battery that has reduced irreversible capacity comprising the step of performing an internal electrochemical pre-charging of the negative electrode prior to final assembly.

25. A material that can be used in the negative electrode of an alkali metal battery that has undergone chemical pre-charging in order to reduce its irreversible capacity upon initially charging the battery.

26. A material as described in claim 25 for use in a lithium battery that has undergone a chemical pre-charging in order to reduce its irreversible capacity upon initially charging the battery.

27. A material as described in claim 25 for use in a sodium battery that has undergone a chemical pre-charging in order to reduce its irreversible capacity upon initially charging the battery.

28. A material as described in claim 25 for use in a potassium battery that has undergone a chemical pre-charging in order to reduce its irreversible capacity upon initially charging the battery.

29. A material that can be used in the negative electrode of an alkali metal battery that has undergone electrochemical pre-charging in order to reduce its irreversible capacity upon initially charging the battery.

30. A material as described in claim 29 that can be used in the negative electrode of a lithium battery that has undergone electrochemical pre-charging in order to reduce its irreversible capacity upon initially charging the battery.

31. A material as described in claim 29 that can be used in the negative electrode of a sodium battery that has undergone electrochemical pre-charging in order to reduce its irreversible capacity upon initially charging the battery.

32. A material as described in claim 29 that can be used in the negative electrode of a potassium battery that has undergone electrochemical pre-charging in order to reduce its irreversible capacity upon initially charging the battery.

33. An electrode for use in an alkali metal battery, the electrode comprising one or more component materials into which the alkali metal was introduced chemically externally to the final electrochemical cell, such that the initial irreversible capacity is greatly reduced.

34. An electrode as described in claim 33 for use in a lithium battery, the electrode comprising one or more component materials into which the lithium was introduced chemically externally to the final electrochemical cell, such that the initial irreversible capacity is greatly reduced.

35. An electrode as described in claim 33 for use in a sodium battery, the electrode comprising one or more component materials into which the sodium was introduced chemically externally to the final electrochemical cell, such that the initial irreversible capacity is greatly reduced.

36. An electrode as described in claim 33 for use in a potassium battery, the electrode comprising one or more component materials into which the potassium was introduced chemically externally to the final electrochemical cell, such that the initial irreversible capacity is greatly reduced

37. An electrode for use in an alkali metal battery, the electrode comprising one or more component materials into which an alkali metal was introduced electrochemically externally prior to the final assembly, such that the initial irreversible capacity is greatly reduced.

38. An electrode as described in claim 37 for use in a lithium battery, the electrode comprising one or more component materials into which lithium was introduced electrochemically externally prior to the final assembly, such that the initial irreversible capacity is greatly reduced.

39. An electrode as described in claim 37 for use in a sodium battery, the electrode comprising one or more component materials into which sodium was introduced electrochemically externally prior to the final assembly, such that the initial irreversible capacity is greatly reduced.

40. An electrode as described in claim 37 for use in a potassium battery, the electrode comprising one or more component materials into which potassium was introduced electrochemically externally prior to the final assembly, such that the initial irreversible capacity is greatly reduced.
